(19) United States
(12) Patent Application Publication
(10) Pub. No.: US 2010/0322286 A1
(43) Pub. Date: Dec. 23, 2010

(54) QUICK-RESPONSE THERMOCOUPLE FOR HIGH-SPEED FLUID

(76) Inventors: Kozo Toyama, Takasago-shi (JP); Mitsuaki Mochizuki, Kobe-shi (JP); Hiroshi Okada, Kobe-shi (JP); Shinichi Fukushima, Kobe-shi (JP); Junichi Sano, Kobe-shi (JP)

Correspondence Address: BIRCH STEWART KOLASCH & BIRCH, PO BOX 747, FALLS CHURCH, VA, 22040-0747, US

(21) Appl. No.: 12/666,105

(22) PCT Filed: Oct. 24, 2008
(86) PCT No.: PCT/JP2008/069830

§ 371 Date: Dec. 22, 2009

(30) Foreign Application Priority Data
Nov. 2, 2007 (JP) 2007-285806

(51) Int. Cl. G01K 7/02

(52) U.S. Cl. 374/179; 374/E07.004

(57) ABSTRACT

An object of the invention is to provide a thermocouple having a high response speed without receiving mechanical damages such as bending and curving even when it is used in a high-speed fluid. The invention provides a quick-response thermocouple for high-speed fluid in which a sheathed thermocouple having a small outer diameter that is formed by housing, in a metal sheath, a positive-side thermocouple filament and a negative-side thermocouple filament embedded within a powder of an inorganic insulating material, and by forming a temperature sensing point at a tip portion thereof by bonding the tips of the positive-side thermocouple filament and the negative-side thermocouple filament together at the tip portion thereof, is inserted in a protective tube having a large outer diameter so that the tip portion is exposed, in which a portion of the sheathed thermocouple that is exposed from the protective tube is inserted in a protective cylinder having a bottom cover with a hole on a tip side through which the sheathed thermocouple is inserted and having a plurality of through windows, the tip of the sheathed thermocouple is slightly exposed from the bottom cover of the protective cylinder, and the bottom cover of the protective cylinder and the sheathed thermocouple as well as the protective cylinder and a lower portion of the protective tube are welded.

### BACKGROUND OF THE INVENTION

(1) Field of the Invention

The present invention relates to a quick-response thermocouple for high-speed fluid, and especially relates to a thermocouple that measures at a high response speed the temperature of a fluid flowing at a high speed such as a fluid in a turbine.

(2) Description of the Related Art

A sheathed thermocouple is formed by housing, in a metal sheath, thermocouple filaments embedded within a powder of an inorganic insulating material such as magnesia or alumina.

A typical shape of the sheathed thermocouple is shown in FIG. 1.

In the sheathed thermocouple, a metal sheath 101 is filled with a powder of an inorganic insulating material 102, where a positive leg (a positive-side thermocouple filament 103) and a negative leg (a negative-side thermocouple filament 104) of the thermocouple are used as the filaments, and tips of the filaments are bonded to be used as a temperature sensing point 105. Although not shown in the drawing, terminals at the tip of the thermocouple and the opposite end therefrom are sealed with a sealer such as epoxy to prevent the powder of an inorganic insulating material 102 from absorbing moisture.

The sheathed thermocouple has been broadly used because it has an advantage of having a longer life compared with a bare wire because the thermocouple filament is isolated from the atmosphere when it is used in a severe environment such as a corrosive atmosphere or an oxidizing atmosphere, and also because the sheathed thermocouple has a merit that there is no necessity to consider insulation from an apparatus in which it is installed because it has an insulating layer.

A method of manufacturing a tip portion of a conventional sheathed thermocouple related to the present invention is shown in FIG. 2.

First, the powder of an inorganic insulating material 102 at the tip portion is raked out and the tips of the thermocouple filaments 103 and 104 are cut off (FIG. 2 (b)).

Next, the temperature sensing point 105 is formed by bonding the tip of the positive-side thermocouple filament 103 and the tip of the negative-side thermocouple filament 104 by welding, etc. (FIG. 2 (c)) . The same powder of an inorganic insulating material 102 is filled in the opened portion where the powder of an inorganic insulating material 102 was previously raked out while leaving some space at the tip (FIG. 2 (d)). Finally, the sheathed thermocouple is completed by sealing the tip of the metal sheath 101 by welding 106 (FIG. 2 (e)).

The smaller the outer diameter of this sheathed thermocouple is, the higher the response speed becomes because its heat capacity is small. However, when the sheathed thermocouple having a small outer diameter is used as it is in a high-speed fluid such as a fluid in a turbine, mechanical damages such as bending and curving occur due to the force from the fluid. Because of this, configurations of a conventional quick-response thermocouple for high-speed fluid (1) shown in FIG. 3 (Japanese Patent Application Laid-Open No. 7-174637), a conventional quick-response thermocouple for high-speed fluid (2) shown in FIG. 4, and a conventional quick-response thermocouple for high-speed fluid (3) shown in FIG. 5 (Japanese Patent Application Laid-Open No. 2006-078305) are considered as thermocouples that do not receive mechanical damages even in a high-speed fluid and that can give quick-response.

In FIG. 3, the sheathed thermocouple consisting of a positive-side thermocouple filament 103, a negative-side thermocouple filament 104, a powder of an inorganic insulating material 102 (1), a metal sheath 101, etc. is housed in a thick protective outer tube 107 and is fixed with a powder of an inorganic insulating material 102 (2).

Because only a tip portion of the sheathed thermocouple where a temperature sensing point 105 is housed is slightly stuck out from the protective outer tube 107, the exposed portion of the sheathed thermocouple does not receive mechanical damages due to the force received from the flow even in a high-speed fluid.

However, the protective outer tube 107 and the powder of an inorganic insulating material 102 (2) have a large diameter and a large heat capacity, temperature-tracking of the protective outer tube 107 and the powder of an inorganic insulating material 102 (2) to a temperature change of a fluid to be measured is slow, and the temperature sensing point 105 of the sheathed thermocouple is influenced by this slow temperature-tracking due to thermal conduction. Therefore, the response speed of the temperature output is slower compared with the response speed of the sheathed thermocouple alone.

FIG. 4 is a modification of FIG. 3 in which a bottom plate 108 is welded to the sheathed thermocouple by attaching the bottom plate 108 to the protective outer tube 107 . No mechanical damage occurs to the sheathed thermocouple the same as the one in FIG. 3. However, the same as for FIG. 3, the response speed of the temperature output is slower compared with the response speed of the sheathed thermocouple alone due to the influence of the large heat capacity of the protective outer tube 107 and the powder of an inorganic insulating material 102 (2).

In FIG. 5, the sheathed thermocouple is housed in a metal protective cylinder 109, and the same as in FIGS. 3 and 4, a temperature sensing point housing portion of the tip of the sheathed thermocouple is slightly stuck out from the protective cylinder 109. The surface of the metal sheath 101 is coated with chrome carbide to cope with wear of the metal sheath 101 due to vibration of the sheathed thermocouple in a high-speed fluid. Because exposure of the tip of the sheathed thermocouple is slight, the sheathed thermocouple does not receive mechanical damages even in a high-speed fluid. However, also in this case, because temperature-tracking of the protective cylinder 109 to the temperature change of the fluid to be measured is slow due to a large heat capacity of the protective cylinder 109, and the protective cylinder 109 contacts with the sheathed thermocouple, the sheathed thermocouple is influenced by this slow temperature-tracking due to thermal conduction, and the response speed is limited.

### SUMMARY OF THE INVENTION

A thermometer is desired that measures with as high a response speed as possible the temperature of a high-speed fluid such as a fluid in a turbine in order to improve performance of an apparatus in which the thermometer is installed. An object of the present invention is to provide a thermocouple that does not receive mechanical damages such as bending and curving even when used in a high-speed fluid and that has a high response speed.

Considering the above-described situation, in order to provide a thermocouple that does not receive mechanical damages such as bending and curving even when used in a high-speed fluid and that has a high response speed, the present invention provides a quick-response thermocouple for high-speed fluid in which a sheathed thermocouple having a small outer diameter that is formed by housing, in a metal sheath, a positive-side thermocouple filament and a negative-side thermocouple filament embedded within a powder of an inorganic insulating material, and by forming a temperature sensing point at a tip portion thereof by bonding tips of the positive-side thermocouple filament and the negative-side thermocouple filament together, is inserted in a protective tube having a large outer diameter so that the tip portion is exposed, in which a portion of the sheathed thermocouple that is exposed from the protective tube is inserted in a protective cylinder having a bottom cover with a hole on a tip side through which the sheathed thermocouple is inserted and having a plurality of through windows, the tip of the sheathed thermocouple is slightly exposed from the bottom cover of the protective cylinder, and the bottom cover of the protective cylinder and the sheathed thermocouple as well as the protective cylinder and a lower portion of the protective tube are welded.

Further, the present invention provides a quick-response thermocouple for high-speed fluid in which the protective cylinder and the metal sheath of the sheathed thermocouple are made of the same material to prevent damages due to a difference in thermal expansion.

Further, the present invention provides a quick-response thermocouple for high-speed fluid in which the powder of an inorganic insulating material that fills the tip portion of the sheathed thermocouple where the temperature sensing point is located is boron nitride or beryllia for improving thermal conductivity, and portions other than the tip portion are filled with a magnesia or alumina powder.

Further, the present invention provides a quick-response thermocouple for high-speed fluid in which a portion farther toward the tip of the sheathed thermocouple than the portion where the temperature sensing point of the sheathed thermocouple is located that is filled with the powder of an inorganic insulating material such as boron nitride or beryllia is filled with a powder of an inorganic insulating material such as magnesia or alumina so that the powder of an inorganic insulating material is fixed so as not to move in the metal sheath and does not scatter during seal-welding.

### BRIEF DESCRIPTION OF THE DRAWINGS

FIG. 1 is a longitudinal sectional drawing and a radial sectional drawing of a conventional sheathed thermocouple;

FIG. 2 is a drawing illustrating a conventional method of manufacturing a tip portion of a sheathed thermocouple;

FIG. 3 is an axial sectional drawing and an arrow A sectional drawing of a conventional quick-response thermocouple for high-speed fluid (1);

FIG. 4 is an axial sectional drawing and an arrow B sectional drawing of a conventional quick-response thermocouple for high-speed fluid (2);

FIG. 5 is an axial sectional drawing and an arrow C sectional drawing of a conventional quick-response thermocouple for high-speed fluid (3);

FIG. 6 is an axial sectional drawing and an arrow D sectional drawing of the quick-response thermocouple for high-speed fluid of the present invention;

FIG. 7 is an outline drawing of the quick-response thermocouple for high-speed fluid of the present invention;

FIG. 8 is a drawing showing a processing procedure (1) of the tip portion of the sheathed thermocouple of the quick-response thermocouple for high-speed fluid of the present invention; and

FIG. 9 is a drawing showing a processing procedure (2) of the tip portion of the sheathed thermocouple of the quick-response thermocouple for high-speed fluid of the present invention.

### DESCRIPTION OF THE PREFERRED EMBODIMENTS

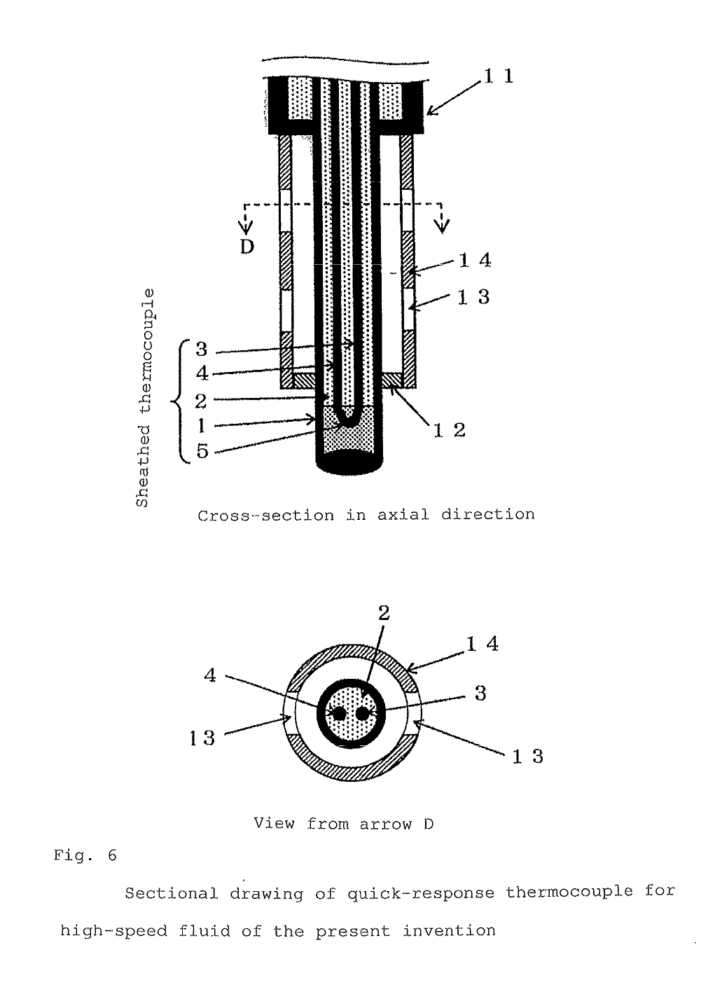

A structure of the thermocouple of the present invention and a method of manufacturing the tip portion of the sheathed thermocouple to be used are shown in FIGS. 6 to 9.

First, the structure is explained.

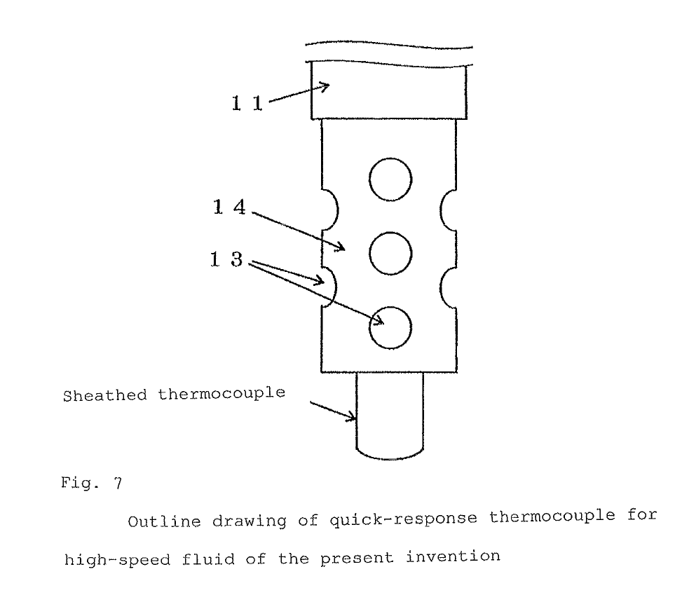

FIG. 6 is a sectional drawing of the thermocouple of the present invention. FIG. 7 is an outline drawing. In the sheathed thermocouple, a metal sheath 1 is filled with a powder of an inorganic insulating material 2, where a positive leg (a positive-side thermocouple filament 3) and a negative leg (a negative-side thermocouple filament 4) of the thermocouple are used as the filaments, and tips of the filaments are bonded to be a temperature sensing point 5.

A hollow protective cylinder 14 having a bottom cover 12 and a plurality of through windows 13 is welded to a protective tube 11 having a large diameter, a sheathed thermocouple having a thin outer shape is housed in the protective cylinder 14, and the tip portion where the temperature sensing point 5 is housed is slightly stuck out from the protective cylinder 14. A material of the protective cylinder 14 is the same as the material of the metal sheath 1 of the sheathed thermocouple.

The sheathed thermocouple is welded to the bottom cover 12 of the protective cylinder 14, and is welded also to the protective tube 11 at a lower portion of the protective tube 11. The protective cylinder 14 and the bottom cover 12 are welded together, or they may be machined out integrally.

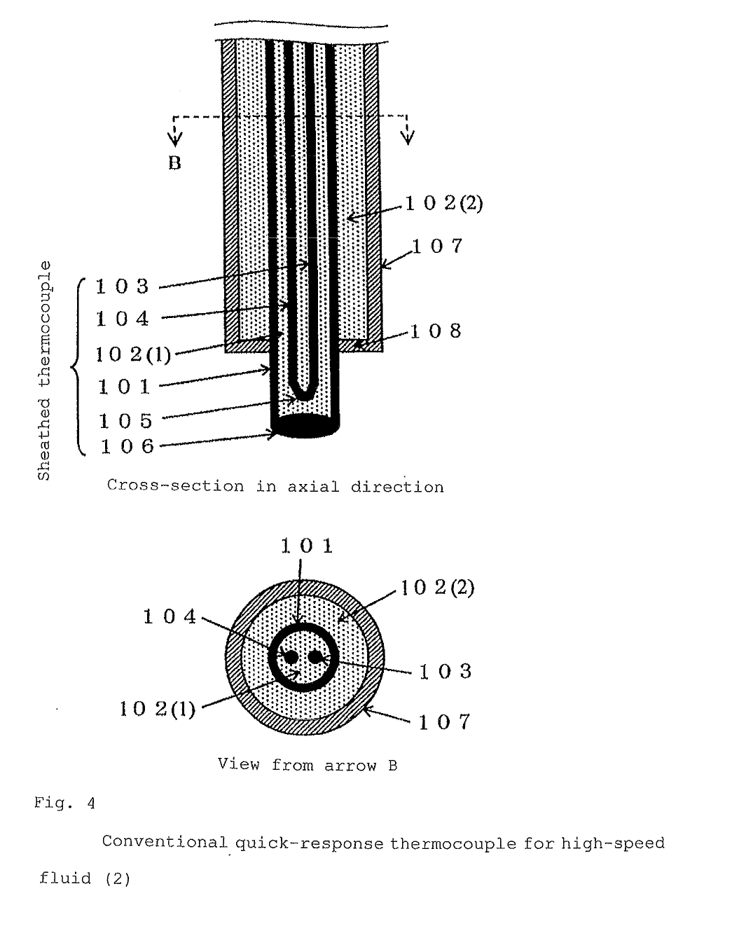

The protective tube 11 may have an internal structure as shown in the upper portion of FIG. 4, or it may have a structure in which a powder of an inorganic insulating material 102 (2) in FIG. 4 is eliminated and the protective tube 11 may be thicken to touch the surface of the metal sheath 1. The internal structure does not matter.

By having the structure as described above, the following effects can be obtained.

1. Quick Response

Tracking of a change of temperature of the fluid to be measured is slower at the portion adjacent to the protective cylinder 14 and the protective tube 11 of the sheathed thermocouple in the protective cylinder 14 compared to the sheathed thermocouple alone due to the effect of thermal conduction from the protective tube 11 portion having a large heat capacity and a slow temperature response.

However, with the structure of the present invention, the fluid to be measured flows also in the protective cylinder 14 through the plurality of through windows 13 that are provided in the protective cylinder 14, and the inner and outer surfaces of the protective cylinder 14 and the bottom cover 12 receive heat transfer from the fluid to be measured.

Because the fluid to be measured flows also about the surface of the sheathed thermocouple in the protective cylinder 14, the sheathed thermocouple also receives heat transfer from the fluid to be measured.

Because of this, the heat transfer from the fluid to be measured becomes predominant at the portion that is apart from the protective cylinder 14 portion of the thermocouple away from the protective tube 11, and the influence from the protective tube 11 portion remains local.

In addition, the protective cylinder 14 is hollow, the heat capacity is small because the bottom cover 12 has a plate shape, and the sheathed thermocouple in the protective cylinder 14 has a small diameter and also has a small heat capacity. Therefore, the lower portion of the protective cylinder 14, the bottom cover 12, and the lower portion of the sheathed thermocouple in the protective cylinder 14 where the effect of the thermal conduction from the protective tube 14 portion disappears all quickly follow the temperature change of the fluid to be measured due to heat transfer from the fluid to be measured.

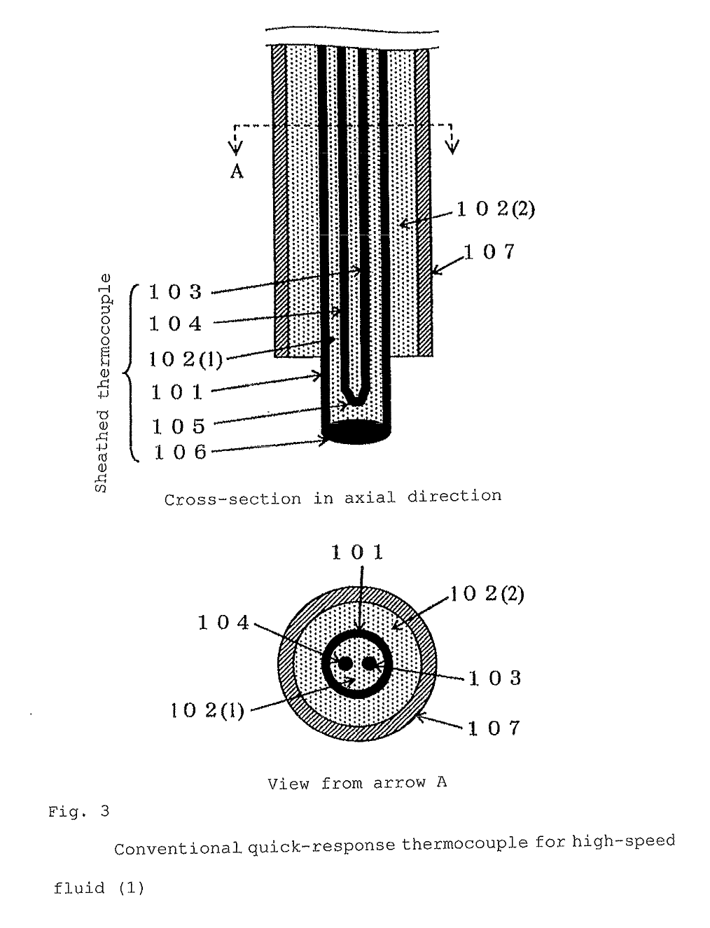

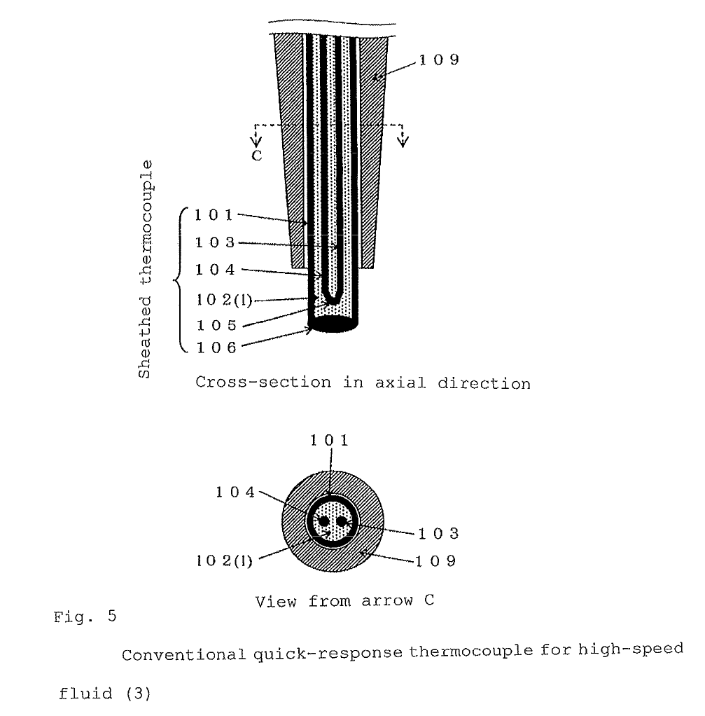

With the conventional structures in FIGS. 3 to 5, the response speed is slower compared to the sheathed thermocouple alone because a temperature sensing point 105 receives from thermal conduction the effect of the slow response due to large heat capacities of a protective outer tube 107 (FIGS. 3 and 4), the powder of an inorganic insulating material 102 (2) (FIGS. 3 and 4), and a protective cylinder 109 (FIG. 5).

With the structure of the present invention, the bottom cover 12 that is connected to the housing portion of the temperature sensing point 5 at the tip of the sheathed thermocouple by welding, the lower portion of the protective cylinder 14 that is connected to the bottom cover 12, and the lower portion of the sheathed thermocouple in the protective cylinder 109 that is connected to the temperature sensing point housing portion quickly follow the temperature change of the fluid to be measured as described above. Therefore, the decrease of the response speed due to heat capacity effects is extremely small. Because of this, a quick-response thermocouple can be obtained having a response speed at the same level as a case where the sheathed thermocouple having a small diameter is used alone.

2. Avoidance of Mechanical Damages

Because the protective cylinder 14 is fixed to the protective tube 11 by welding and is a circular cylinder having the bottom cover 12, mechanical damages such as bending, curving, and buckling in a high-speed fluid can be avoided even without having a large thickness owing to a so-called three-dimensional effect of the structure. Because a large thickness is not necessary, the heat capacities of the protective cylinder 14 and the bottom cover 12 can be made small, and this contributes to an improvement of the response speed.

The thermocouple of the present invention does not receive damage due to wear because it does not have a moving part as in the structure of FIG. 5.

Further, because the tip portion of the sheathed thermocouple is only slightly stuck out from the protective cylinder 14 similarly to the conventional one, this portion does not receive mechanical damages by the force received from a high-speed fluid.

For damages due to thermal expansion when used under high temperatures, damages due to a difference in thermal expansion can be prevented by making the protective cylinder 14 and the metal sheath 1 with the same material.

That is, each of the protective cylinder 14 and the sheathed thermocouple is fixed to the lower portion of the protective tube 11 by welding, and the protective cylinder 14 and the sheathed thermocouple are fixed to the bottom cover 12 of the protective cylinder by welding. Because of this, when there is a difference in thermal expansion between the protective cylinder 14 and the sheathed thermocouple, there is a possibility that damages occur due to the difference in thermal expansion between the lower portion of the protective tube 11 and the bottom cover 12 during use under high temperatures. However, damages due to the difference in thermal expansion can be prevented by making the protective cylinder 14 and the metal sheath 1 with the same material.

Next, the improvement of the responsiveness of the sheathed thermocouple itself is explained.

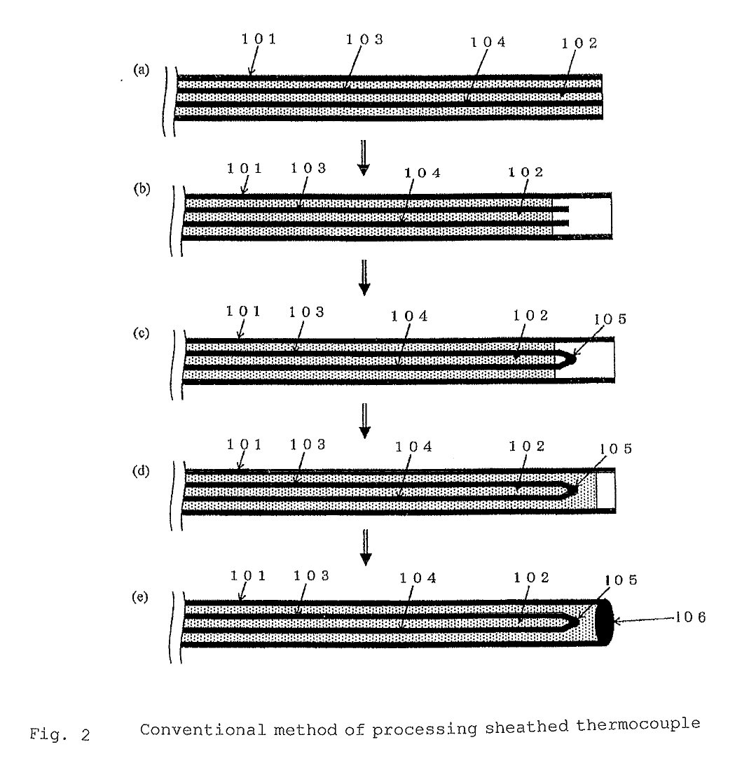

The tip portion of the sheathed thermocouple is made as shown in FIG. 2. A magnesia powder or an alumina powder is used as the powder of an insulating material mainly for economical reasons.

A metal sheath 101 shown in FIG. 2 (a) , in which thermocouple filaments 103 and 104 and a powder of an inorganic insulating material 102 are housed, is made thick initially, and then undergoes a process of reducing the diameter by cold-drawing using a swaging machine or a die in the final step of production. Therefore, it is tightly filled with the powder of an inorganic insulating material 102 at high density, and because of that, the thermal conductivity is good. However, because such a process of reducing the diameter is not performed on the powder of an inorganic insulating material 102 that fills in the circumference of the temperature sensing point 105 in the tip portion in FIG. 2 (d) , the filling density is low and the thermal conductivity is poor. Because of that, the time in which the temperature of the metal sheath 101 transfers to the temperature sensing point 105 is long, and it is a cause of the limitation of the response speed of the sheathed thermocouple.

In the present invention, the response speed of the sheathed thermocouple itself is increased by using a powder of an inorganic insulating material having good thermal conduction to fill the tip portion of this sheathed thermocouple.

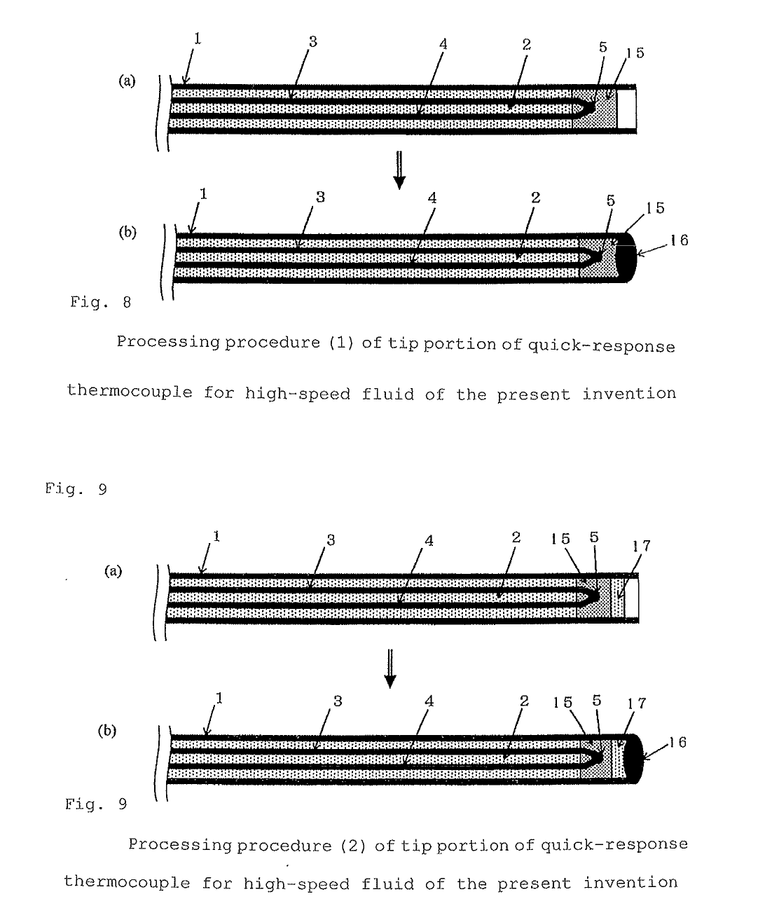

The processing procedure is shown in FIG. 8. The procedure up to the formation of the temperature sensing point 5 is the same as the conventional procedure shown in FIG. 2, and the powder of an inorganic insulating material used is also a magnesia powder or an alumina powder.

The material of the powder of an inorganic insulating material 15 that fills the circumference of the temperature sensing point 5 in the tip portion afterwards is a boron nitride powder or a beryllia powder that has good thermal conductivity. With this configuration, the response of the sheathed thermocouple is increased without losing economical benefit by making the used amount of expensive boron nitride or beryllia to be minimum.

When the powder of an inorganic insulating material that fills the tip has a characteristic of flowing smoothly due to properties such as the surface friction coefficient in a processing procedure (a) of FIG. 8, the powder of an inorganic insulating material cannot fixedly fill the metal sheath 1 without flowing, and when tip seal-welding 16 of FIG. 8 (b) is performed, a phenomenon occurs in which the filled powder of an inorganic insulating material 15 scatters out of the metal sheath 1 with the thermal expansion of air that is in the space between the powder particles. From experience, especially the boron nitride powder tends to behave as such.

A processing procedure to deal with the scattering of the powder of an inorganic insulating material is shown in FIG. 9.

The procedure up to the filling of the circumference of the temperature sensing point 5 in the tip with the powder of an inorganic insulating material having good thermal conductivity is the same as that in FIG. 8.

After this, a portion further closer to the tip is filled with a magnesia or alumina powder 17 which is the same as the conventional one, and the tip is sealed by the tip seal-welding 16. Magnesia and alumina powders that are generally used can be fixed in the metal sheath 1 so as not to move. It is proved by the conventional processing that the powders do not scatter during the seal-welding, and scattering did not actually occur with this processing procedure even when the boron nitride powder that scatters in the procedure of FIG. 8 is used as the inorganic insulating material having good thermal conduction.

### EXAMPLES

### Example 1

First, an example of the improvement of the response speed of the sheathed thermocouple itself is explained.

A sheathed thermocouple was produced according to the processing procedure shown in FIG. 9.

Type of thermocouple filament: K thermocouple filament shown in JISC1602

Sheath outer diameter: φ3.2 mm

Sheath material: NCF600

Material of powder of inorganic insulating material: magnesia

Material of powder of inorganic insulating material having good thermal conduction that filled the vicinity of temperature sensing point: boron nitride

Material of powder of inorganic insulating material that filled the tip to prevent scattering: magnesia

The response speed was measured by dropping this sheathed thermocouple into water having a flow rate of 1 m/sec from air at room temperature. As a result, a response time constant (the time that is required for the output change to achieve 63.2% of the total change) was 0.46 seconds.

On the other hand, the response time constant of the sheathed thermocouple having the same thermocouple filament type, sheath outer diameter, sheath material, and material of the powder of an inorganic insulating material as the sheathed thermocouple formed according to the conventional processing procedure shown in FIG. 2 was measured to be 0.56 seconds with the same measurement method. The response speed was improved by about 18% in terms of the response time constant by the present invention.

Next, an example is explained in which the quick-response thermocouple of the present invention was produced using the sheathed thermocouple of the above-described invention.

The shape is as shown in FIGS. 6 and 7, and the main dimensions and materials are as follows.

Outer diameter of protective cylinder: φ8 mm

Thickness of protective cylinder: 1 mm

Length of protective cylinder: 22 mm

Materials of protective cylinder and bottom cover: NCF600

Through windows of protective cylinder: 10 circular windows of φ2.3 mm (the arrangement of the windows is as shown in FIG. 7)

Thickness of bottom cover of protective cylinder: 3 mm

Length of exposed tip of sheathed thermocouple: 9 mm

Similarly to the test of the sheathed thermocouple alone, the response speed was measured by dropping this sheathed thermocouple in water having a flow rate of 1 m/sec from air at room temperature. The response time constant was 0.50 to 0.55 seconds. The difference with the response time constant 0.46 seconds of the sheathed thermocouple used alone is very small, and it proves that the structure of the present invention can make the decrease in response speed extremely small by providing the protective cylinder.

In the above-described quick-response thermocouple that was produced, the shapes and materials of the sheathed thermocouple and the protective cylinder were determined for measuring the fluid temperature in a turbine so that mechanical damages do not occur even at the maximum flow rate at the place where the thermocouple is placed for use.

Conventionally, the tip of the thermocouple that is used at the same place has a shape shown in FIG. 4. This conventional thermocouple is also designed so that mechanical damages do not occur even at the maximum flow rate at the place where the thermocouple is placed for use. However, the response time constant that was measured by dropping this sheathed thermocouple in water having a flow rate of 1 m/sec from air at room temperature was about 2 seconds.

As described above, the response speed of the quick-response thermocouple of the present invention is increased by about 4 times as indicated by the response time constant compared with the conventional one.

In the present invention, the temperature of a high-speed fluid can be measured with quick response, and the temperature of a high-speed fluid containing small particles can also be measured.

The present invention provides a quick-response thermocouple for high-speed fluid in which a sheathed thermocouple having a small outer diameter that is formed by housing, in a metal sheath, a positive-side thermocouple filament and a negative-side thermocouple filament embedded within a powder of an inorganic insulating material, and by forming a temperature sensing point at a tip portion thereof by bonding the tips of the positive-side thermocouple filament and the negative-side thermocouple filament together, is inserted in a protective tube having a large outer diameter so that the tip portion is exposed, in which a portion of the sheathed thermocouple that is exposed from the protective tube is inserted in a protective cylinder having a bottom cover with a hole on a tip side through which the sheathed thermocouple is inserted and having a plurality of through windows, the tip of the sheathed thermocouple is slightly exposed from the bottom cover of the protective cylinder, and the bottom cover of the protective cylinder and the sheathed thermocouple as well as the protective cylinder and a lower portion of the protective tube are welded. Therefore, a thermocouple that does not receive mechanical damages even in a high-speed fluid and that responds quickly due to a new structure is obtained although the thermocouple is similar to the conventional one in a point that the sheathed thermocouple having a small diameter is used.

Further, because the present invention provides a quick-response thermocouple for high-speed fluid in which the protective cylinder and the metal sheath of the sheathed thermocouple are made of the same material, damages due to a difference in heat expansion can be prevented.

Further, because the present invention provides a quick-response thermocouple for high-speed fluid in which a powder of an inorganic insulating material that fills the tip portion of the sheathed thermocouple where the temperature sensing point is located is boron nitride or beryllia having good thermal conductivity, and portions other than the tip portion are filled with a magnesia or alumina powder, the responsiveness of the sheathed thermocouple itself to be used can be improved with a small increase of the cost.

Further, because the present invention provides a quick-response thermocouple for high-speed fluid in which a portion farthest toward the tip of the sheathed thermocouple than the portion where the temperature sensing point of the sheathed thermocouple is located that is filled with the powder of an inorganic insulating material such as boron nitride or beryllia is filled with a powder of an inorganic insulating material such as magnesia or alumina, the powder of an inorganic insulating material can be fixed in the metal sheath so as not to move and can be made not to scatter during seal-welding.

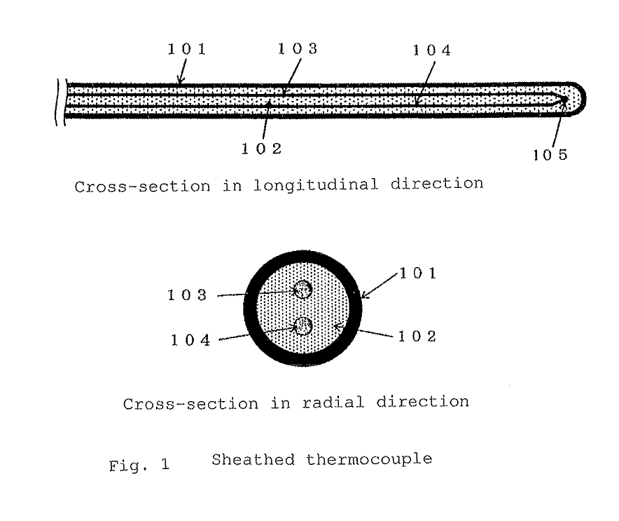

FIG. 1

1. Cross-section in longitudinal direction

2. Cross-section in radial direction

3. FIG. 1

Sheathed thermocouple

FIG. 2

1. Conventional method of processing sheathed thermocouple

FIG. 3

1. Sheathed thermocouple

2. Cross-section in axial direction

3. View from arrow A

4. FIG. 3

Conventional quick-response thermocouple for high-speed fluid (1)

FIG. 4

1. Sheathed thermocouple

2. Cross-section in axial direction

3. View from arrow B

4. FIG. 4

Conventional quick-response thermocouple for high-speed fluid (2)

FIG. 5

1. Sheathed thermocouple

2. Cross-section in axial direction

3. View from arrow C

4. FIG. 5

Conventional quick-response thermocouple for high-speed fluid (3)

FIG. 6

1. Sheathed thermocouple

2. Cross-section in axial direction

3. View from arrow D

4. FIG. 6

Sectional drawing of quick-response thermocouple for high-speed fluid of the present invention

FIG. 7

1. Sheathed thermocouple

2. FIG. 7

Outline drawing of quick-response thermocouple for high-speed fluid of the present invention

FIG. 8

1. FIG. 8

Processing procedure (1) of tip portion of quick-response thermocouple for high-speed fluid of the present invention

FIG. 9

1. FIG. 9

Processing procedure (2) of tip portion of quick-response thermocouple for high-speed fluid of the present invention

1. A quick-response thermocouple for high-speed fluid wherein a sheathed thermocouple having a small outer diameter that is formed by housing, in a metal sheath, a positive-side thermocouple filament and a negative-side thermocouple filament embedded within a powder of an inorganic insulating material, and by forming a temperature sensing point at a tip portion thereof by bonding tips of the positive-side thermocouple filament and the negative-side thermocouple filament together, is inserted in a protective tube having a large outer diameter so that the tip portion is exposed, wherein
a portion of the sheathed thermocouple that is exposed from the protective tube is inserted in a protective cylinder having a bottom cover with a hole on a tip side through which the sheathed thermocouple is inserted and having a plurality of through windows, the tip of the sheathed thermocouple is slightly exposed from the bottom cover of the protective cylinder, and the bottom cover of the protective cylinder and the sheathed thermocouple as well as the protective cylinder and a lower portion of the protective tube are welded.

2. The quick-response thermocouple for high-speed fluid according to claim 1, wherein the protective cylinder and the metal sheath of the sheathed thermocouple are made of the same material.

3. The quick-response thermocouple for high-speed fluid according to claim 1, wherein the powder of an inorganic insulating material that fills the tip portion of the sheathed thermocouple where the temperature sensing point is located is boron nitride or beryllia, and portions other than the tip portion are filled with a magnesia or alumina powder.

4. The quick-response thermocouple for high-speed fluid according to claim 3, wherein a portion farther toward the tip of the sheathed thermocouple than the portion where the temperature sensing point of the sheathed thermocouple is located that is filled with the powder of an inorganic insulating material such as boron nitride or beryllia is filled with a powder of an inorganic insulating material such as magnesia or alumina.

5. The quick-response thermocouple for high-speed fluid according to claim 2, wherein the powder of an inorganic insulating material that fills the tip portion of the sheathed thermocouple where the temperature sensing point is located is boron nitride or beryllia, and portions other than the tip portion are filled with a magnesia or alumina powder.
